(19) United States
(12) Patent Application Publication
(10) Pub. No.: US 2003/0016592 A1
(43) Pub. Date: Jan. 23, 2003

(54) Magneto-optical head and magneto-optical read/write apparatus

(76) Inventors: Toru Katakura, Miyagi (JP); Kenjiro Watanabe, Tokyo (JP)

Correspondence Address: SONNENSCHEIN NATH & ROSENTHAL, P.O. BOX 061080, WACKER DRIVE STATION, CHICAGO, IL, 60606-1080, US

(21) Appl. No.: 10/171,074

(22) Filed: Jun. 13, 2002

(30) Foreign Application Priority Data
Jun. 20, 2001 (JP) P2001-186971

(51) Int. Cl. G11B 11/00

(52) U.S. Cl. 369/13.23

(57) ABSTRACT

There is provided a magneto-optical head including a magnetic field applying means having optimum electromagnetic conversion efficiency and capable of applying a magnetic field having favorable distribution to a recording medium, and a magneto-optical read/write apparatus which has the magneto-optical head allowing reduction of power consumption of a disk drive. The magneto-optical head includes a light transmitting section for transmitting light provided to a slider floating over a recording medium, and a magnetic field applying means arranged around the light transmitting section. The magnetic field applying means includes a thin film coil and a magnetic material serving as a magnetic field generating yoke having a portion disposed on the side of the recording medium and another portion disposed on the opposite side to the recording medium. The magneto-optical read/write apparatus has the magneto-optical head for reading/writing information stored in the recording medium.

### CROSS REFERENCE TO RELATED APPLICATIONS

This application claims priority to Japanese Patent Application No. JP 2001-128971, filed on Jun. 20, 2001, the disclosure of such application being herein incorporated by reference to the extent permitted by law.

### BACKGROUND OF THE INVENTION

1. Field of the Invention

The present invention relates to a magneto-optical head and a magneto-optical read/write apparatus for performing magneto-optical writing (recording) on a recording medium.

2. Related Art

Conventionally, a recording medium such as a magneto-optical disk (optical disc) in which a recording layer is irradiated with light for reading/writing a signal has been predominantly used. A higher recording density is needed to allow recording of as much information as possible.

With such a trend towards higher recording density in an optical disk, attempts have been made to increase recording density by reducing the diameter of a spot of light irradiated to a surface of an optical disk on which a signal is recorded with respect to an optical pickup for recording/playing back a signal on the optical disk.

In recent years, particularly, read/write of a signal on an optical disk has been proposed in which the technique of a floating head slider used in a hard disk apparatus or the like is applied such that an optical lens is mounted on a slider to constitute an optical head slider, and while the slider floats over a signal recording surface of the optical disk by a predetermined amount, the optical lens mounted on the slider gathers and irradiates light to the signal recording surface of the optical disk.

The use of such an optical head slider may significantly reduce the distance between the optical lens and the signal recording (writing) surface of the optical disk as compared with irradiation of light from an optical head to a signal recording surface of an optical disk.

This allows the use of an optical lens with a large NA (Numerical Aperture), and as a result, it is possible to reduce the diameter of a spot of light irradiated to the signal recording surface of the optical disk.

In addition, when the aforementioned magneto-optical disk is used as a recording medium, a magnetic field applying means is needed for applying a magnetic field to the magneto-optical disk at the time of recording.

It is more desirable to have the magnetic field applying means integrated to the aforementioned optical head slider than to be separated from the slider, for achieving a smaller and simpler apparatus.

When the magnetic field applying means is provided integrated to the optical head slider as mentioned above, the magnetic field applying means may includes, for example, a thin film coil buried in the surface of the slider facing the magneto-optical disk such that the coil is wound around the focal point of laser light.

In the case of the aforementioned magnetic field applying means including the thin film coil integrated to the optical head slider, configurations have been proposed in which a magnetic field generating yoke made of a magnetic material is disposed on the side of the thin film coil opposite to the side closer to a recording medium (magneto-optical disk) (see FIGS. 10A to 10C) for enhancing a magnetic field produced from the thin film coil.

These configuration, however, have not become commercially available due to low electromagnetic conversion efficiency in the thin film coil.

In addition, a magnetic field applied to the recording medium has an unfavorable distribution.

For this reason, when recording is performed on the magneto-optical disk, an extremely high current of 150 mA or more is required for obtaining a magnetic field of, for example 250Oe or higher, perpendicular to the surface of the medium.

Under such conditions, a driving IC capable of quick operation of the coil cannot be formed, and a disk drive having the head slider has high power consumption.

### SUMMARY OF THE INVENTION

In order to alleviate the aforementioned problems, the present invention provides a magneto-optical head achieving high electromagnetic conversion efficiency in a magnetic field applying means and capable of applying a magnetic field of a satisfactory distribution to a recording medium, and a magneto-optical read/write apparatus having the magneto-optical head to enable a reduction in power consumption of a disk drive.

A magneto-optical head according to a preferred embodiment of the present invention includes a light transmitting section for transmitting light provided in a slider moving in the air over a recording medium; and a magnetic field applying means arranged around the light transmitting section; the magnetic field applying means includes a thin film coil and a magnetic material forming a magnetic field generating yoke having a portion disposed on the side of the recording medium and another portion disposed on an opposite side to the recording medium, on the thin film coil.

Another preferred embodiment of the present invention includes a magneto-optical read/write apparatus for reading/writing information on a recording medium, including: a light transmitting section provided on a slider that floats over the recording medium, for transmission of light; and a magnetic field applying means arranged around the light transmitting section; the magnetic field applying means includes a magneto-optical head including a thin film coil and a magnetic material forming a magnetic field generating yoke having a portion disposed on the side of the recording medium and another portion disposed on an opposite side to the recording medium, on the thin film coil.

According to the aforementioned configuration of the magneto-optical head of the present invention, since the light transmitting section for transmitting light is provided in the slider over the recording medium, light passes through the slider through the light transmitting section to irradiate the recording medium with light required for reading/writing information.

In addition, the magnetic field applying means arranged around the light transmitting section can apply a magnetic field required for recording information on the recording medium so as to allow supplying the light beam and the magnetic field to the recording medium from the same side.

Furthermore, since the magnetic field applying means is formed of the thin film coil and the magnetic material serving as the magnetic field generating yoke having the portion disposed on the side of the thin film coil closer to the recording medium and the portion disposed on the opposite side of the coil farther from the recording medium, a magnetic field produced by the thin film coil can be efficiently applied to the recording medium with a controlled strength and distribution by the magnetic material of the magnetic field generating yoke.

According to the aforementioned configuration of the magneto-optical read/write apparatus of the present invention, since the aforementioned magneto-optical head of the present invention included therein can efficiently apply a magnetic field to the recording medium, a magnetic field required for recording can be applied to the recording medium, for example even when a smaller amount of electric current than conventional is supplied to the thin film coil of the magnetic field applying means.

According to the magneto-optical head of the present invention, a strong magnetic field having favorable distribution can be efficiently applied to the recording medium.

In particular, the magneto-optical head may enhance the strength of the magnetic field as compared with the prior art in which the magnetic field generating yoke made of the magnetic material is disposed only on the side of the thin film coil that is opposite to the side of the recording medium.

In addition, according to the magneto-optical read/write apparatus of the present invention, power consumption of the disk drive may be reduced to achieve a reduction in power consumption of the magneto-optical read/write apparatus.

As a result, the thin film coil of the magnetic field applying means may be driven at high speed to perform read/write at high recording density.

### BRIEF DESCRIPTION OF THE DRAWINGS

The above and other objects, features and advantages of the present invention will become more apparent to those skilled in the art from the following description of the presently preferred exemplary embodiments of the invention taken in conjunction with the accompanying drawings, in which:

FIG. 1 is a schematic diagram showing main portions (around a magneto-optical head) of a magneto-optical read/write apparatus according to a preferred embodiment of the present invention;

FIG. 2 is an schematic enlarged view of a magnetic field applying means according to the preferred embodiment of the present invention shown in FIG. 1;

FIG. 3 is a schematic perspective view showing a specific structure of the magneto-optical head 10 configured as shown in FIGS. 1 and 2;

FIG. 4 is a diagram showing a detailed configuration of the magnetic field applying means according to the preferred embodiment of the present invention shown in FIG. 2;

FIGS. 5A to 5C show manufacturing steps illustrating a method of manufacturing the magneto-optical head shown in FIG. 3;

FIGS. 6A to 6C show manufacturing steps illustrating the method of manufacturing the magneto-optical head shown in FIG. 3;

FIGS. 7A to 7C show manufacturing steps illustrating the method of manufacturing the magneto-optical head shown in FIG. 3;

FIGS. 8A to 8C show manufacturing steps illustrating the method of manufacturing the magneto-optical head shown in FIG. 3;

FIG. 9 is a diagram showing an exemplary cross sectional structure of a magneto-optical disk according to a preferred embodiment of the present invention; and

FIGS. 10A to 10C are schematic diagrams showing conventional magneto-optical heads having magnetic field generating yokes provided for thin film coils.

### DESCRIPTION OF THE PREFERRED EMBODIMENTS OF THE PRESENT INVENTION

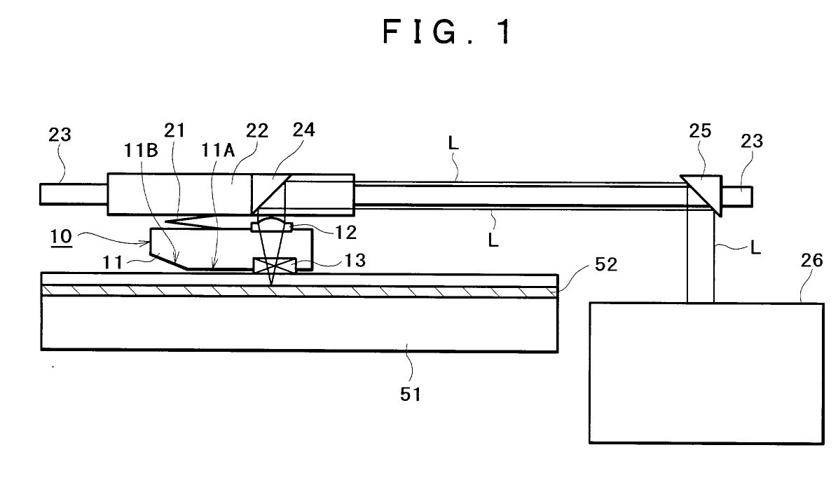

FIG. 1 is a schematic diagram showing main portions (a magneto-optical head and its surroundings) of a magneto-optical read/write apparatus as a preferred embodiment of the present invention.

The magneto-optical read/write apparatus uses a magneto-optical disk 51 as a recording medium to read/write information on a recording layer 52 formed in the disk 51, and includes a magneto-optical head 10 for such purpose.

The magneto-optical head 10 includes a slider 11 attached to a member 22 moving in parallel along a rail 23 extending as an arm through an elastic member 21 implemented by a spring, for example, a lens 12 disposed on and inside the slider 11, and a magnetic field applying means 13 provided inside the slider 11.

The slider 11 has a slanted portion on its left side (in the figure) where an air bearing surface 11B is formed for producing flotation from an airflow caused by the rotation of the magneto-optical disk 51. The air bearing surface 11B thus formed receives the airflow caused by the rotation of the magneto-optical disk 51 to produce flotation, which makes the slider 11 float over the magneto-optical disk 51 by a predetermined amount.

It is to be noted that the shape of the air bearing surface 11B is not particularly limited, so many arbitrary shapes may be applicable.

The member 22, the rail 23 and a driving means, not shown, are used to perform linear motor driving, thereby moving the magneto-optical head 10 in parallel with the magneto-optical disk 51.

Mirrors 24, 25 are disposed respectively at ends of the member 22 and the rail 23. The mirrors 24, 25 reflect laser light L emitted from an optical element section 26 comprising a laser diode, a photodiode or the like to guide the light L to the magneto-optical head 10.

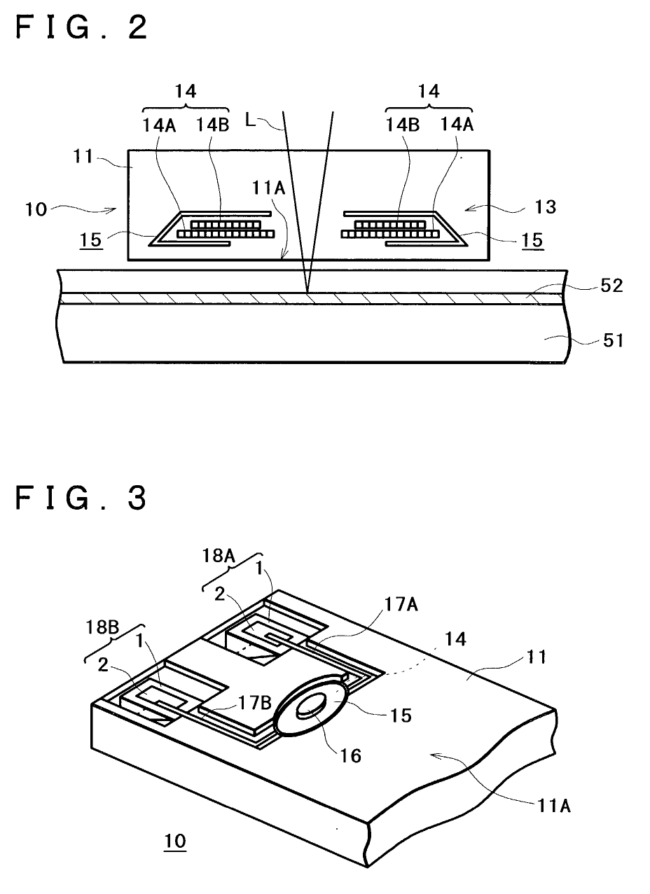

FIG. 2 is a schematic enlarged view of the magnetic field applying means 13 of FIG. 1 and its surroundings.

The magnetic field applying means 13 includes a thin film coil 14 and a magnetic field generating yoke 15 made of a magnetic material. It should be noted that the central portion of the magnetic field applying means 13 is not provided with the thin film coil 14 or the magnetic field generating yoke 15 for transmitting the laser light L.

The thin film coil 14 is formed of two stages for the purpose of increasing the number of turns and includes a first thin film coil 14A positioned closer to the magneto-optical disk 51 that works as a recording medium and a second thin film coil 14B farther from the disk 51, and the first thin film coil 14A has more turns than that of the second thin film coil 14B.

The magnetic field generating yoke 15 is disposed so as to surround the thin film coil 14 in U-shape.

On the other hand, the laser light L for reading/writing information on the magneto-optical disk 51 enters the central portion (a light transmitting section to be described later) of the thin film coil 14 from the back of the slider 11, exits the slider 11 from the side of a sliding surface (an ABS surface) 11A thereof, reaches the recording layer 52 of the magneto-optical disk 51, is reflected from the recording layer 52 and then travels back (returns) through the same path.

In this event, the lens 12 of the magneto-optical head 10, a prism of the optical element section 26 and the like are used to separate the incident light from the reflected light for preventing interference between them.

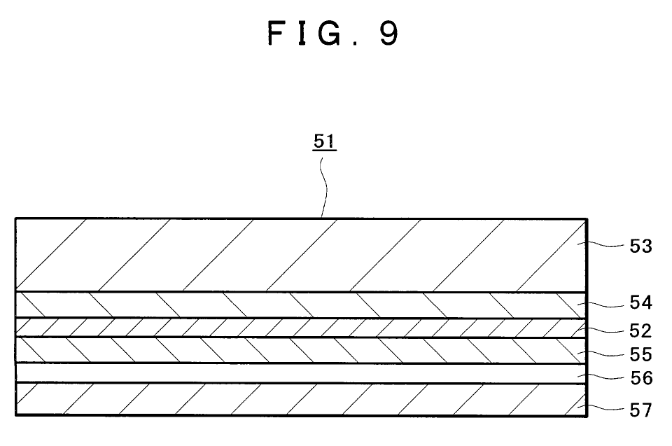

FIG. 9 shows an exemplary structure in cross section of the magneto-optical disk 51 applicable to the present invention.

As shown in FIG. 9, the magneto-optical disk 51 includes a polycarbonate substrate 53, a first dielectric film 54 made of, for example an Si₃N₄ film having a thickness of 145 nm, a recording layer 52 made of, for example a TbFeCoCr film having a thickness of 25 nm, a second dielectric film 55 made of, for example an Si₃N₄ film having a thickness of 100 nm, a reflecting film 56 made of, for example an AlTi film having a thickness of 100 nm, and a protecting layer 57.

Deflected laser light L is irradiated to the disk 51 from the polycarbonate substrate 53, passes through the recording layer 52, reflected by the reflecting film 56, and again passes through the recording layer 52 to return. As the deflected laser light L passes through the recording layer 52, the direction of deflection is rotated.

Vertical magnetic reversal in the recording layer 52 changes the Kerr rotation angle of the deflected laser light L, so that the change in the Kerr rotation angle can be detected to obtain a signal corresponding to the contents of information (0 or 1).

In the magneto-optical head 10 of the preferred embodiment of the present invention, since the magnetic field applying means 13 and the exit of the laser light L are arranged on the same side of the head 10 with respect to the magneto-optical disk 51, both of a magnetic field and the laser light L are supplied to the disk 51 from the polycarbonate substrate 53.

FIG. 3 is a perspective view showing a preferred embodiment of structure for the magneto-optical head 10 configured as shown in FIG. 1 and FIG. 2. FIG. 3 shows the slider 11 of the magneto-optical head 10 viewed from the magneto-optical disk 51. While the air bearing surface 11B is formed on the slider 11 in FIG. 1, the air bearing surface 11B is omitted in FIG. 3.

The magnetic field generating yoke 15 is provided in a doughnut shape around the cylindrical light transmitting section 16 for transmitting the laser light L, and the thin film coil 14 is disposed beneath the yoke 15.

The diameter of the light transmitting section 16 is, for example, 50 μm for a typical magneto-optical disk 51. The thin film coil 14 is formed to have a two-layer structure with 34 turns (the number of the winding turns).

Wires 17A, 17B extend from the thin film coil 14 and are connected to terminal sections 18A, 18B, respectively.

The thin film coil 14, the magnetic field generating yoke 15, and the wires 17A, 17B are arranged in grooves formed on the slider 11.

The terminal sections 18A, 18B are formed on slanted grooves formed obliquely so as to extend also to a lateral side of the slider 11 and embedding a first metal 1 such as gold and a second metal 2 such as copper, for example. The wires 17A, 17B are connected to the second metal 2 (for example, copper) of the terminals 18A, 18B.

Leads (not shown) made of gold, for example, are connected to the sides of the terminal sections 18A, 18B (to which the first metal 1 extends) with bonding wires or the like to allow supply of electrical current from the outside for the thin film coil 14 (14A, 14B) to produce a magnetic field.

In addition, a lens 12 is provided as shown in FIG. 1 on the opposite side of the slider 11 farther from the magneto-optical disk 51.

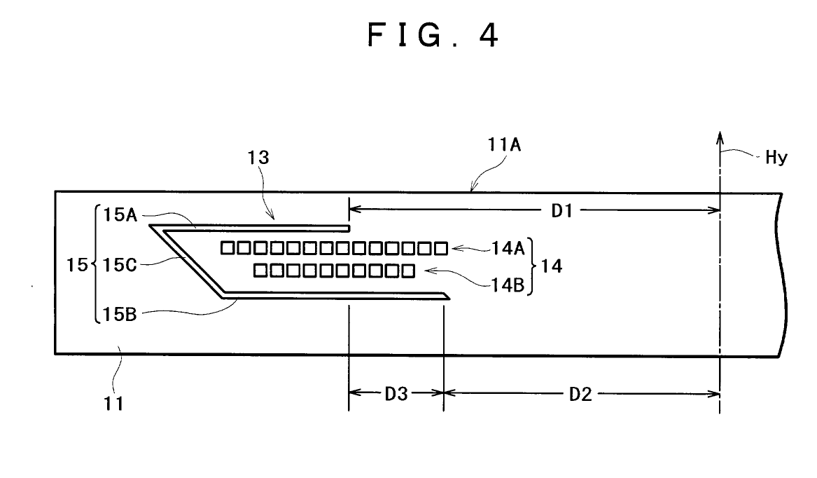

Furthermore, FIG. 4 shows the detailed configuration of the magnetic field applying means 13 of FIG. 2. FIG. 4 shows only the magnetic field applying means 13 from the center to one end with the sliding surface (ABS surface) I A side up.

As in FIG. 2, the first thin film coil 14A and the second thin film coil 14B form the thin film coil 14 of two stages, and the magnetic field generating yoke 15 made of a magnetic material (for example, permalloy) is arranged to surround the thin film coil 14 in a U-shape.

The magnetic field generating yoke 15 has a first portion 15A on the side of the coil 14 closer to the sliding surface 11A, a second portion 15B on the opposite side of the coil 14 farther from the sliding surface 11A, and a third portion 15C obliquely arranged outside the thin film coil 14.

The first portion 15A of the magnetic field generating yoke 15 defines an opening of length D1 from the center of a magnetic field of the magnetic field applying means 13.

The second portion 15B of the magnetic field generating yoke 15 defines an opening of length D2 from the center of the magnetic field of the magnetic field applying means.

In this event, the opening of the first portion 15A is larger than the opening of the second portion 15B by a length D3 (D3=D1−D2).

A magnetic field may be applied to the recording medium with a controlled strength and distribution through the opening of the first portion 15A of the magnetic field generating yoke 15.

In addition, a magnetic field of an optimal distribution can be applied to the magneto-optical disk 51 by adjusting (providing the appropriate difference D3 in) the lengths D1, D2 of the openings of the portions 15A, 15B of the magnetic field generating yoke 15.

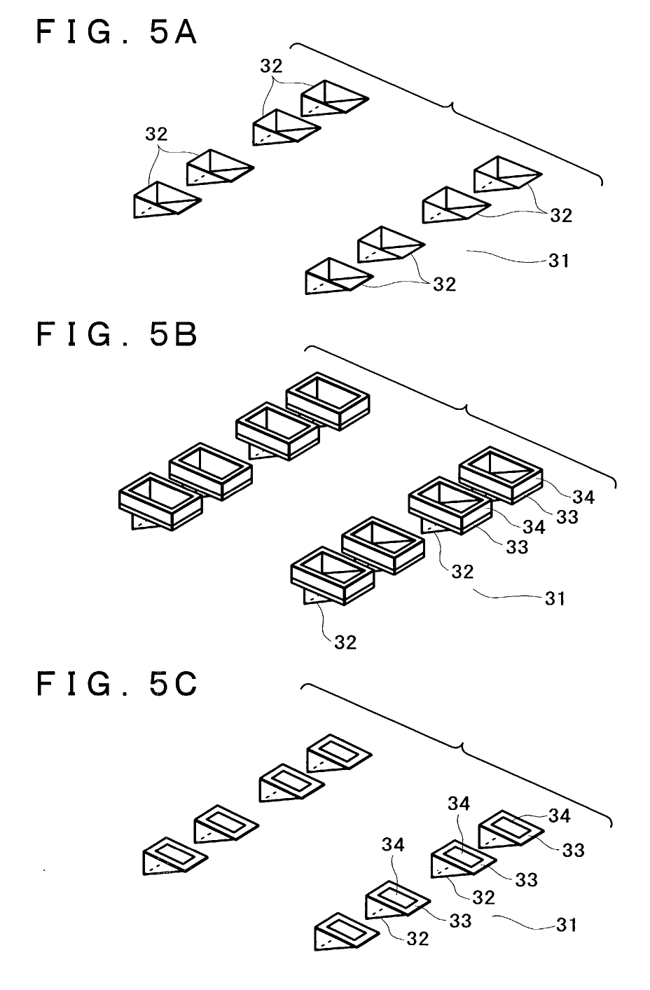

In addition, FIGS. 5 to 9 show steps of manufacturing the magneto-optical head 10 shown in FIG. 3.

It should be noted that FIGS. 5 to 9 also show the magneto-optical head 10 viewed from a side which is closer to the magneto-optical disk 51, that is, from the side of the sliding surface 11A of the slider 11, similarly to FIG. 3. In the following, description will be made assuming that the direction closer to the magneto-optical disk 51 is defined as “up,” while the direction farther from the disk 51 is defined as “down.”

As the substrate, a glass substrate having the same refractive index as the lens (lens 12 in FIG. 1) is used for gathering the laser light L used for reading/writing (recording/reproducing).

The substrate is for collectively manufacturing a number of magneto-optical heads 10 before the substrate is finally cut and divided into individual sliders 11.

Next, as shown in FIGS. 5A to 5C, terminal for electric connection between the thin film coil 14 and a circuit such as an amplifier are formed on the glass substrate 31 by using a powder beam (reference to Patent Application No. 2000-46834).

Specifically, a resist (not shown) is formed on a main surface of the glass substrate 31, and a mask (not shown) having openings in portions corresponding to the terminal sections is used to perform exposure and development for patterning. This operation forms openings in portions of the resist corresponding to the terminal sections. Then, the resist is sufficiently dried and baking is performed.

Next, a jet stream(powder beam) of compressed air containing dispersed abrasives is injected at a predetermined angle oblique to the main surface of the glass substrate 31 having the resist formed thereon. In this manner, the glass substrate 31 is etched.

The resist mask is then removed, and terminal grooves 32 having bottoms inclined in a depth direction are formed in the glass substrate 31 as shown in FIG. 5A.

Subsequently, the glass substrate 31 is washed and dried, and then a plating underlying film (not shown), for example a laminated film of Cr/Cu, is formed over the entire surface thereof with a sputtering process.

In addition, a resist (not shown) is formed on the plating underlying film to form openings somewhat larger than the terminal grooves 32 on the terminal grooves 32. The resist is then sufficiently dried and baking is performed.

Next, first metal and second metal are successively deposited as plating films at a thickness larger than the depth of the terminal grooves 32 to some extent.

Specifically, gold, for example, is deposited as the first metal at a thickness of 50 μm, and successively, copper, for example, is deposited as the second metal at a thickness of 250 μm, with plating.

The resist is then removed, and laminated first metal 33 and second metal 34 are formed on the glass substrate 31 inside and around the terminal grooves 32.

Subsequently, the glass substrate 31 is washed and dried, and then polishing is performed to flat smoothen the surface of the glass substrate 31 to a desired level, thereby leaving the first metal 33 and the second metal 34 in the terminal grooves 32 as shown in FIG. 5C.

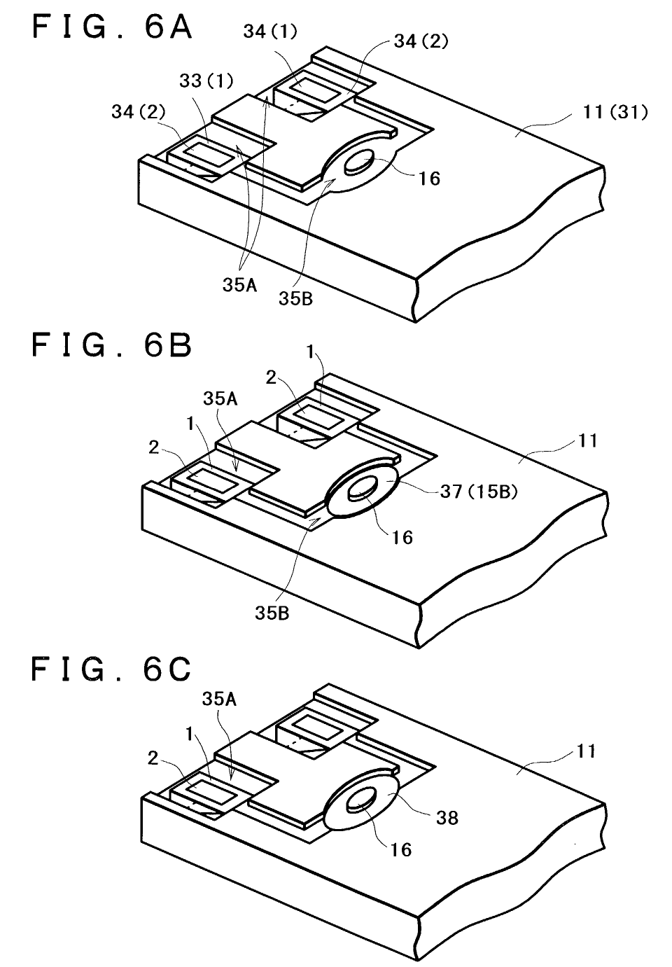

FIG. 6A and subsequent figures show one slider 11 extracted from the substrate.

Next, as shown in FIG. 6A, the glass substrate 31 (slider 11) is subjected to ion etching to form a groove 35. The groove 35 is roughly separated into a terminal section and wire forming groove 35A and a coil forming groove 35B.

In this event, the coil forming groove 35B is formed in a doughnut shape to allow the cylindrical light transmitting section 16 to be formed in the center.

The groove 35 has to be formed at a thickness of, for example 40 μm in the glass substrate 31. However, due to a slow etching rate of 5 μm/h for the glass, continuous etching of the groove to the thickness of 40 μm leads to a problem of increasing the temperature at the surface of the glass substrate 31 to cause foaming which deforms the pattern.

In addition, while a positive resist of a Novolac type, for example, may be used as the resist, it is difficult to form fine patterns when the resist is deposited at a large thickness such as 30 μm or more.

Thus, etching to a thickness of 10 μm is typically performed four times to achieve etching to a thickness of 40 μm in total.

Next, as shown in FIG. 6B, permalloy is deposited with frame plating in the coil forming groove 35B to form a magnetic film 37 which is to serve as the second portion 15B of the magnetic field generating yoke 15.

The thickness of the plating may be approximately 3 to 4 μm.

The pattern of the magnetic film 37 is formed to be slightly smaller than the coil forming groove 35B as shown in FIG. 6B.

Then, as shown in FIG. 6C, a resist film 38 AZ-4400 manufactured by Tokyo Ohka Kogyo Co., Ltd. is for example deposited at 3000 rpm and a thickness of approximately 4 μm to ensure insulation between the thin film coil and the magnetic film 37. In this event, patterning is performed such that the resist film 38 is not left in the outer area of the magnetic film 37 as the second portion 15B of the magnetic field generating yoke to provide magnetic connection to the first portion 15A of the magnetic field generating yoke (for example, approximately 5 μm from the yoke: however, the resist film 38 is left to approximately 10 μm outward from the magnetic field generating yoke in the area where a wire 17B extends across the yoke to prevent an electrical short of the yoke and the wire 17B) and in the light transmitting section 16.

Subsequently, the resist film 38 is hardened (subjected to resist cure) at approximately 280 [symbol] C in vacuum. In this event, the resist film 38 may be hardened in a rotating magnetic field in a vacuum at approximately 4 kOe to avoid deteriorating the magnetic characteristics of the permalloy of the magnetic film 37.

Next, to form the lower coil 14B of two layers of the coils 14A, 14B with pattern plating of copper, a Cr film having thickness of 20 nm and a Cu film having thickness of 100 nm, for example, are successively deposited as plating growth films (plating underlying films) with the sputtering process. Of the films, as the Cr film is provided in order to improving the adhesion between the resist and the Cu film, Ti, Ta or the like may be alternatively used.

Then, a fine resist pattern is formed to form the thin film coil in the groove 35B. For example, SIPR-9270 manufactured by Shin-Etsu Chemical Co., Ltd., may be used to deposit a resist, and then patterns corresponding to the second thin film coil and the associated wire are removed (extracted) in order to form the resist pattern.

Next, Cu, is deposited having for example a thickness of 3 μm as a plating film 39 with an electroplating process using a copper sulfate solution.

Then, the resist is removed by a solvent such as acetone.

Finally, ion etching is performed over the entire surface in order to remove the unnecessary plating growth layer.

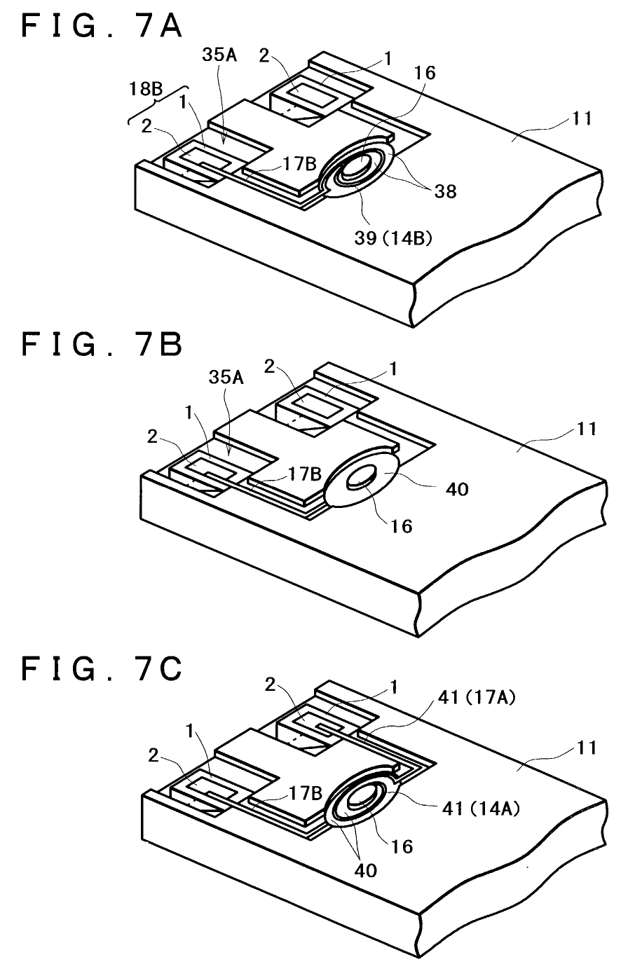

In this manner, as shown in FIG. 7A, the second thin film coil 14B and the wire 17B are formed by the plating film 39, and the wire 17B is connected to the second metal 2 constituting the terminal section 18B.

Next, in order to maintain insulation between the upper and lower two thin film coils 14A, 14B, steps are performed similar to the aforementioned steps of forming the resist film 38. Specifically, as shown in FIG. 7B, a resist film 40 is formed to cover the second thin film coil 14B. However, a connection window is formed on the end on the opposite side to the wire 17B of the second thin film coil 14B to allow connection between the first thin film coil 14A and the second thin film coil 14B. Patterning is performed such that the resist film 40 is not left in the outer area of the magnetic film 37 as the second portion 15B of the magnetic field generating yoke to provide magnetic connection to the first portion 15A of the magnetic field generating yoke (for example, approximately 5 μm from the yoke: however, in order to prevent an electrical short of the yoke and the wire 17A, approximately 10 μm of the resist film 40 is left outward from the magnetic field generating yoke in the area where the wire 17A extends across the yoke) and in the light transmitting section 16.

Then, the resist film 40 is patterned to perform resist cure.

Next, a plating growth film (plating underlying film) of Cr/Cu is deposited with sputtering to form the first thin film coil 14A. Subsequent steps are performed similarly to the aforementioned ones.

Specifically, a resist pattern corresponding to the first thin film coil 14A and the associated wire is formed on the plating growth film to deposit a plating film 41 of, for example Cu, with electroplating.

The resist is removed by a solvent and the unnecessary plating growth film is etched off to form the first thin film coil 14A and the associated wire 17A by the plating film 41 as shown in FIG. 7C, and the wire 17A is connected to the second metal 2 constituting the terminal section 18A.

At this point, the thin film coil 14 included of the first thin film coil 14A and the second thin film coil 14B is completed.

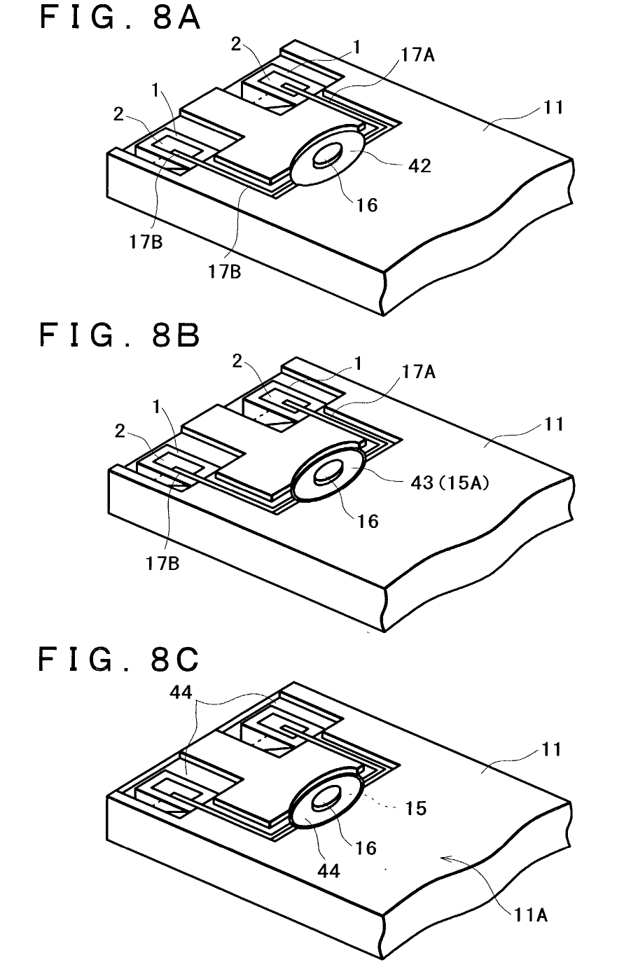

Next, as shown in FIG. 8A, a resist cure film 42 is formed to ensure insulation between the magnetic layer of the first portion 15A of the magnetic field generating yoke and the first thin film coil 14A.

Also, in this event, patterning is performed such that the resist film 42 is not left in the outer area of the magnetic film 37 of the second portion 15B of the magnetic field generating yoke to provide magnetic connection to the first portion 15A of the magnetic field generating yoke (for example, approximately 5 μm from the yoke: however, the resist film 42 is left to approximately 10 μm outward from the yoke in the portion where the wire 17A extends across the magnetic field generating yoke to prevent an electrical short of the yoke and the wire 17A) and in the light transmitting section 16.

Subsequently, similarly to the lower magnetic film 37, permalloy is deposited as a magnetic film 43 at a thickness of approximately 4 μm with flame plating and is patterned to form the first portion 15A of the magnetic field generating yoke 15 comprised of the magnetic film 43 as shown in FIG. 8B.

Simultaneously or almost simultaneously, the third portion 15C of the magnetic field generating yoke is formed in the openings formed in the resist films 38, 40, and 42.

In this manner, the magnetic field generating yoke 15 surrounding the thin film coil 14 substantially in a U-shape is completed.

Next, alumina is deposited as a protecting film 44 at a thickness approximately equal to the depth of the groove 35, for example approximately 40 μm.

Then, flat smoothening is performed by mechanical polishing in order to again expose the surface of the glass substrate 31 as shown in FIG. 8C, thereby leaving the protecting film 44 in the groove 35.

Thereafter, the glass substrate 31 is polished to reach the thickness identical to the thickness of a final chip and the wafer is cut into individual chips on which processing is performed for forming the air bearing surface 11B. Then, each chip is bonded to a suspension.

The third portion 15C of the magnetic field generating yoke corresponding to the side wall need not be formed over the entire periphery, and it is essential only that the first portion 15A is magnetically connected to the second portion 15B.

It is not desirable that the wires 17A, 17B of the thin film coil 14 and the magnetic field generating yoke 15 are short-circuited.

As a result, the third portion 15C of the magnetic field generating yoke 15 is formed to avoid the portions of the thin film coil 14 from which the wires 17A, 17B are drawn. To that end, the resist films 38, 40, and 42 are formed above and below the wires 17A, 17B in the outer area of the magnetic field generating yoke to avoid contact between the magnetic field generating yoke 15 and the wires 17A, 17B.

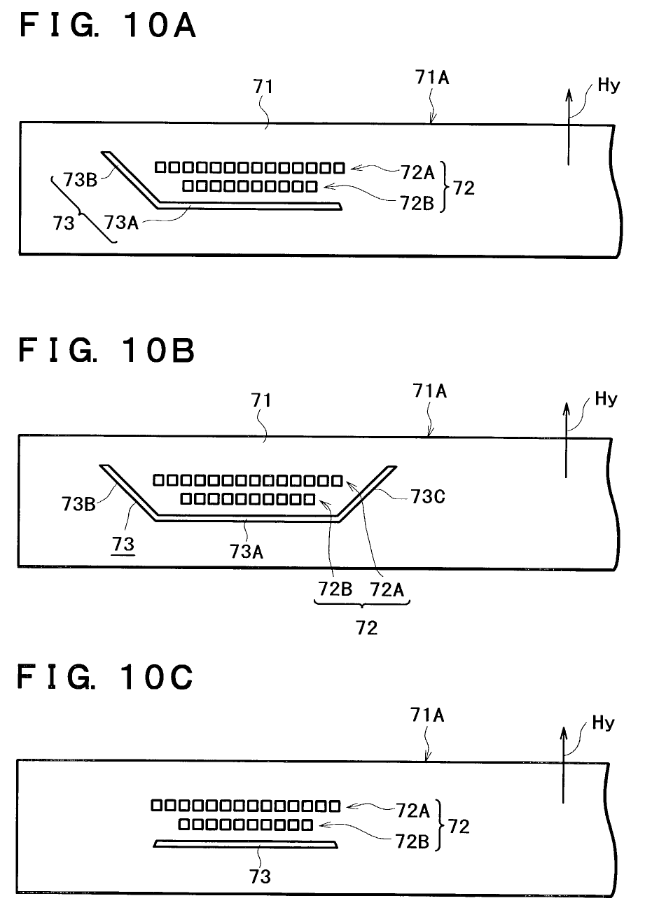

The configuration of the magneto-optical head 10 of the preferred embodiment of the present invention was compared to conventional configurations for the magneto-optical heads shown in FIGS. 10A to 10C in terms of the strength and distribution of a magnetic field applied to a recording medium (magneto-optical disk).

First, a vertical magnetic field strength Hy at the center of the thin film coil serving as the magnetic field center was calculated for each of the configuration of the preferred embodiment shown in FIG. 4, the configuration as shown in FIG. 10A in which a magnetic field generating yoke 73 is provided below a thin film coil 72, that is, on a side 73A opposite to the side closer to the recording medium and an outer side 73B, the configuration as shown in FIG. 10B in which the magnetic field generating yoke 73 is provided below the thin film coil 72, that is, on a side 73A opposite to the side closer to the recording medium, an outer side 73B and an inner side 73C, and the configuration as shown in FIG. 10C in which the magnetic field generating yoke 73 is provided only below the thin film coil 72, that is, on the opposite side to the side closer to the recording medium.

The calculations have been made on the following conditions, assuming that the respective configurations have the same dimensions and number of turns of the thin film coils 14, 73, the same thickness of the magnetic field generating yokes 15, 72, and the same distances from the magnetic field center to the yokes:

Current through thin film coil: 75 mA

Turns of thin film coil: 34 turns

Width of thin film coil: 3 μm

Height of thin film coil: 3 μm

Pitch of turns of thin film coil: 2 μm

Spacing between thin film coil and magnetic field generating yoke: 4 μm

Spacing between first thin film coil and second thin film coil: 4 μm

Thickness of magnetic field generating yoke: 2 μm

Magnetic Permeability of magnetic field generating yoke: 1000

Diameter of optical transmitting region: 50 μm

The sliding surface 11A in FIG. 4 was arranged 10 μm above the first portion 15A of the magnetic field generating yoke, and the distance from the thin film coil 72 to the sliding surface 71A was set to the same as that in FIG. 4 in each of the configurations in FIGS. 10A to 10C.

The calculation results are as follows:

Configuration shown in FIG. 4:

Hy=2.12×10⁴A/m(270Oe)

Configuration shown in FIG. 10A:

Hy=1.73×10⁴A/m(220Oe)

Configuration shown in FIG. 10B:

Hy=1.26×10⁴A/m(160Oe)

Configuration shown in FIG. 10C:

Hy=1.41×10⁴A/m(180Oe)

It can be seen from those results that a greater vertical field Hy is obtained and a greater magnetic field can be applied to the recording medium from the same current in the configuration as shown in FIG. 4 including the magnetic field generating yoke disposed on the side of the thin film coil closer to the recording medium to provide the magnetic field generating yoke extending both above and below the thin film coil.

Then, the difference D3 in the lengths of the openings of the first portion 15A and the second portion 15B of the magnetic field generating yoke 15 was changed in the embodiment shown in FIG. 4 in order to examine changes in the strength of the vertical field Hy.

As a example of comparison, similar calculations have been made for the configuration shown in FIG. 10C.

The calculations have been made on the following conditions:

Current through thin film coil: 75 mA

Turns of thin film coil: 34 turns

Width of thin film coil: 3 μm

Height of thin film coil: 3 μm

Pitch of turns of thin film coil: 2 μm

Spacing between thin film coil and magnetic field generating yoke: 4 μm

Spacing between first thin film coil and second thin film coil: 4 μm

Thickness of magnetic field generating yoke: 3 μm

Magnetic Permeability of magnetic field generating yoke: 1000

Diameter of optical transmitting region: 50 μm

Inner diameter of magnetic field generating yoke below thin film coil (length D2 of opening): 60 μm (radius)

Outer diameter of magnetic field generating yoke: 285 μm (radius)

The difference D3 in the lengths of the openings of the upper and lower magnetic field generating yokes 15A, 15B was changed to 5 μm, 20 μm, 40 μm, and 60 μm, and for each length, the strength of the magnetic field was calculated at a position 40 μm away from the magnetic field generating yoke below the thin film coil both on the center of the magnetic field of the magnetic field generating yoke and at a position 25 μm away outward from the magnetic field center.

The calculation results (relative values of the vertical field Hy) are shown in Table 1.

TABLE 1

vertical magnetic field (relative
value) 40 μm upward from lower
shield

| | | magnetic field | 25 μm from |
|---|---|---|---|
| D3 | | center | center |
| no lower shield | | 1.01 | 1.07 |
| 5 | μm | 1.31 | 1.35 |
| 20 | μm | 1.37 | 1.44 |
| 40 | μm | 1.31 | 1.37 |
| 60 | μm | 1.25 | 1.33 |

From Table 1, the strongest vertical field Hy at the position 40 μm away upward from the lower magnetic field generating yoke 15B was obtained when the difference D3 in the lengths of the upper and lower openings of the magnetic field generating yoke is 20 μm (inner diameter 80 μm (radius) of the upper magnetic field generating yoke 15A/60 μm (radius) of the lower magnetic layer) in the configuration in FIG. 4. This strongest vertical field Hy was found both on the center of and at the position 25 μm away outward from the magnetic field center.

It can also be seen that the configuration in FIG. 4 exhibited stronger vertical fields Hy as compared with the configuration in FIG. 10C.

If another condition is changed, the optimal value of the difference D3 in the lengths of the upper and lower openings of the magnetic field generating yoke is changed. For example, a change in distance from the thin film coil to the recording layer 52 of the magneto-optical disk causes a change in the lengths D1, D2 of the openings at which the optimal vertical magnetic field Hy is obtained, so that the optimal value of the difference D3 in the lengths of the openings is also changed.

In this event, the lengths D1, D2 of the openings may be set to obtain the optimal vertical field Hy.

According to the aforementioned preferred embodiments of the present invention, since the magnetic field generating yoke 15 made of the magnetic material is provided as the magnetic field applying means 13 of the magneto-optical head 10 in addition to the thin film coil 14, a magnetic field produced from the thin film coil 14 can be controlled by the magnetic field generating yoke 15.

Thus, the magnetic field produced from the thin film coil 14 can be applied with a controlled strength and distribution to the magneto-optical disk 51.

In addition, the magnetic field generating yoke 15 is shaped such that it has the first portion 15A on the side of the thin film coil 14 closer to the recording medium 51, the second portion 15B on the opposite side, and the third portion 15C connecting the two portions 15A, 15B to surround the thin film coil 14 substantially in a U-shape. This shape allows a strong magnetic field of a favorable distribution to be applied efficiently to the magneto-optical disk 51 from the opening of the first portion 15A of the magnetic field generating yoke 15.

Thus, the electromagnetic conversion efficiency of the thin film coil 14 can be improved to apply a stronger magnetic field to the magneto-optical disk 51 even when a current amount supplied to the thin film coil 14 is not changed.

Even when a smaller amount of current than conventional is supplied to the thin film coil 14, a magnetic field required for recording on the magneto-optical disk 51 can be applied thereto.

It is thus possible to form a driving IC capable of the operation of the thin film coil 14 at high speed. Such fast driving of the thin film coil 14 can provide for high density record.

When a disk drive comprising the magneto-optical head 10 in the embodiment is formed to implement a magneto-optical read/write apparatus for reading/writing (recording/playing back) information on the magneto-optical disk 51, thin film coil 14 of the magnetic field applying means 13 of the magneto-optical head 10 has favorable electromagnetic conversion efficiency and a magnetic field of a favorable distribution is applied to the magneto-optical disk 51. Thus, read/write can be performed with high recording density.

In addition, power consumption of the disk drive can be reduced to result in a reduction in power consumption of the magneto-optical read/write apparatus.

It should be noted that the light transmitting section 16 may be formed as a perforation (opening) by boring a through hole in the slider 11, and in this case, the laser light L can be transmitted therethrough similarly.

However, when a lens is disposed in the light transmitting section 16, the light transmitting section is preferably formed of an optical material, not of the perforation, for protecting the lens from dirt.

In addition, the light transmitting section 16 formed of such an optical material can provide for a near field optical system, for example.

While the magneto-optical head 10 is linearly driven by the member 22 and the rail 23, and thus movable from the inner radius to the outer radius of the magneto-optical disk 51 in the aforementioned preferred embodiment of the present invention, another alternative configurations may be applied.

For example, the magneto-optical head may be attached to an arm that is pivotally moved about the pivot point at the end of the arm so as to allow movement of the magneto-optical head from the inner radius to the outer radius of the magneto-optical disk.

Although the invention having been described in its preferred form with a certain degree of particularity, other changes, variations, combinations and sub-combinations are possible therein. It is therefore to be understood that any modifications will be practiced otherwise than as specifically described herein without departing from the scope and spirit of the present invention.

What is claimed is:

1. A magneto-optical head comprising:
a light transmitting section for transmitting light provided in a slider moving in the air over a recording medium; and
magnetic field applying means arranged around said light transmitting section; wherein
said magnetic field applying means includes a thin film coil and a magnetic material forming a magnetic field generating yoke having a portion disposed on the side of said recording medium and another portion disposed on an opposite side to said recording medium, on said thin film coil.

2. The magneto-optical head according to claim 1, wherein said magnetic material is continuously formed in order to make said portion on the side of said recording medium be magnetically connected to said another portion on the opposite side to said recording medium.

3. The magneto-optical head according to claim 1, wherein said magnetic material has an aperture for said light transmitting section on the side of said recording medium having a diameter which is larger than a diameter of an opening on the opposite side.

4. The magneto-optical head according to claim 1, wherein said thin film coil comprises a coil having two layers.

5. A magneto-optical read/write apparatus for reading/writing information on a recording medium, said apparatus comprising:
a light transmitting section provided on a slider that floats over said recording medium, for transmission of light; and
a magnetic field applying means arranged around said light transmitting section; wherein
said magnetic field applying means includes a magneto-optical head comprising a thin film coil and a magnetic material forming a magnetic field generating yoke having a portion disposed on the side of said recording medium and another portion disposed on an opposite side to said recording medium, on said thin film coil.
